(19) United States
(12) Patent Application Publication
(10) Pub. No.: US 2009/0284850 A1
(43) Pub. Date: Nov. 19, 2009

(54) DEVICE AND METHOD FOR LOCKING LENS

(75) Inventors: Chih-Ming Huang, Hsinchu City (TW); Chih-Lun Chen, Hsinchu City (TW)

Correspondence Address: HAVERSTOCK & OWENS LLP, 162 N WOLFE ROAD, SUNNYVALE, CA, 94086, US

(73) Assignee: MUSTEK TECHNOLOGY CO.,LTD, Hsinchu City (TW)

(21) Appl. No.: 12/353,726

(22) Filed: Jan. 14, 2009

(30) Foreign Application Priority Data
May 15, 2008 (TW) 097117911

(51) Int. Cl. G02B 7/02

(52) U.S. Cl. 359/823

(57) ABSTRACT

A device and a method for locking lens in a lens holder are provided, wherein the lens is configured in a voice-coil motor (VCM) of a camera module of a cell phone and the VCM has a lens holder for a lens being fixed inside. The device includes a circumgyration stop instrument having a bottom surface for urging against the top surface of the lens holder for preventing a lateral stress and a lateral movement from occurring on the lens holder while the circumgyration stopping unit is coupled with the lens holder.

### FIELD OF THE INVENTION

The present invention relates to a device and a method for locking lens used in a voice-coil motor of a photographing module of a cell phone, and more particularly relates to a device and a method for locking a lens in lens holder by using a circumgyration stopping instrument having a smooth bottom surface

### BACKGROUND OF THE INVENTION

In general, the camera module of a photographic cell-phone is configured with a Voice-Coil Motor (VCM), which is the solution with the lowest cost as well as the minimum volume for the auto-focusing function. Furthermore, the mechanical structure of the VCM is durable and vibration resistible. The main components of the VCM are a magnet and a coil, and a relative motion is generated by the repellence of the magnetic fields produced by the electric current going through the coil. Besides the camera modules with auto-focusing function, the VCM is also applied in the rest technical fields (such as the reader head of a hard disk) of the Micro-Electro Mechanical System (MEMS).

Since the photo pixels of a photographic cell-phone are being promoted constantly, the image quality of the camera module therein is important, hence the image quality should be adjusted to an optimum condition when a lens is focused in the camera module in the manufacturing procedure. However, the products are easily damaged while focusing a lens by using a circumgyration stopping instrument according to the prior art.

Please refer to FIG. 1, which is a schematic diagram showing the side section diagram of the focusing a lens in a lens holder according to the prior art. As shown in FIG. 1, there are a lens holder 11 and four leaf springs 10 in a VCM, and a circumgyration stopping instrument 13 is adopted to fix the lens holder 11 before locking a lens 12 in the lens holder 11. Namely, three or four position sticks 14 of the circumgyration stopping instrument 13 are previously plugged into the four position holes 15 of the lens holder 11, and then the lens 12 is rotated to be fixed into the lens holder 11.

Please refer to FIG. 2, which is a schematic diagram showing the side section diagram of the circumgyration stopping instrument and lens holder in combination process. As shown in FIG. 2, while the lens holder 11 is operated to be fixed by the circumgyration stopping instrument 13, the four position sticks 14 of the circumgyration stopping instrument 13 are operated to be plugged downward into the four position holes 15 of the lens holder 11. Since the plugging process is often operated inexactly, i.e. the position sticks 14 are not often aimed to the center of the position holes 15, a lateral force LF is often generated to lead to a condition of the inclined lens holder 11, as a result, the leaf springs are deformed and the VCM is damaged. Therefore, it is needed to improve the mechanism for the combination of the circumgyration stopping instrument 13 and the lens holder 11.

From the above description, in order to overcome the drawbacks in the prior art, a device and a method for locking lens in a lens holder are provided by the inventor via the diligent research and perseverance working.

### SUMMARY OF THE INVENTION

In accordance with one aspect of the present invention, a lens locking device and method is provided to prevent a lateral stress and a lateral movement generated while the circumgyration stopping instrument is coupled with the lens holder, therefore the lens holder is prevented from inclination and the leaf springs of the VCM of the camera module is prevented from damage.

In accordance with another aspect of the present invention, a lens locking device for locking a lens into a lens holder is provided, the device comprises a focusing ring and a circumgyration stopping unit, wherein the focusing ring is configured for fixing the lens to the lens holder, and the circumgyration stopping unit has a bottom surface urging against a top surface of the lens holder for preventing a lateral stress from occurring on the lens holder while the circumgyration stopping unit is coupled with the lens holder.

Preferably, the lens locking device further

Preferably, the bottom surface of the circumgyration stopping unit urges the top surface with a normal stress so that a frictional force is generated between the bottom surface and the top surface of the lens holder, so as to fix the lens holder to the circumgyration stopping unit, wherein the top surface and the bottom surface are both smooth and have no bulges thereon.

Preferably, the circumgyration stopping unit further comprises a funnel part enhancing the normal stress.

Preferably, the lens has an indentation and the focusing ring is configured in the indentation and rotated to fix the lens to the lens holder.

Preferably, the lens and the lens holder are configured in a voice-coil motor of a photographing module of a cell phone.

Preferably, the lens locking device according to claim 1 further comprising a base supporting the lens holder and a rotation positioning board rotatably connected with the base.

Preferably, the rotation positioning board comprises a first fillister used for holding a positioning rod on the positioning the circumgyration stopping unit for positioning the circumgyration stopping unit.

Preferably, the rotation positioning board further comprises a second fillister used for containing the lens holder.

In accordance with another aspect of the present invention, a lens locking apparatus is provided. The lens locking apparatus comprises a lens, a lens holder, and a circumgyration stopping instrument, wherein the lens holder has a top surface, and the circumgyration stopping instrument has a bottom surface for urging against the top surface of the lens holder for preventing a lateral stress from occurring on the lens holder while the circumgyration stopping unit contacts with the lens holder.

Preferably, the lens has an indentation and a focusing ring is configured in the indentation to fix the lens to the lens holder.

Preferably, the bottom surface of the circumgyration stopping instrument urges the top surface of the lens holder with a downward stress, and the bottom surface and the top surface have a frictional force therebetween to fix the lens holder to the circumgyration stopping instrument, and both of the top surface and the bottom surface are smooth.

Preferably, the circumgyration stopping instrument further comprises a first part enhancing the downward stress.

Preferably, the lens and the lens holder are configured in a voice-coil motor of a camera module of a cell phone.

Preferably, the lens locking apparatus further comprises a base supporting the lens holder and a rotatably positioning board connected to the base.

In accordance with another aspect of the present invention, a method for locking a lens to a lens holder is provided. The method comprises the steps of: providing a stopping device having a smooth bottom surface and a focusing ring; urging the bottom surface against the top surface of the lens holder; putting the focusing ring onto the lens; and fixing the lens to the lens holder by the focusing ring, wherein the lens holder is prevent from a lateral movement while the stopping device is coupled with the lens holder.

Preferably, the step of fixing the lens to the lens holder is performed by rotating the lens by the focusing ring until the lens is fixed to the lens holder.

Preferably, the urging step further comprises a step of enhancing a downward stress applied onto the top surface by an enhancing part of the stopping device.

Preferably, the urging step further comprises a step of enhancing a frictional force between the top surface and the bottom surface to prevent the lens holder from rotating.

Preferably, the method for locking a lens to a lens holder farther comprising steps of: providing a positioning board, and positioning the stopping device onto the positioning board.

Preferably, the method or locking a lens to a lens holder further comprising a step of providing a base having a rod rotatably connected with the positioning board and supporting the positioning board.

The above objects and advantages of the present invention will become more readily apparently to those ordinarily skilled in the art after reviewing the following detailed descriptions and accompanying drawings, in which:

### BRIEF DESCRIPTION OF THE DRAWINGS

FIG. 1 is a schematic diagram showing the side section diagram of the focusing a lens in a lens holder according to the prior art;

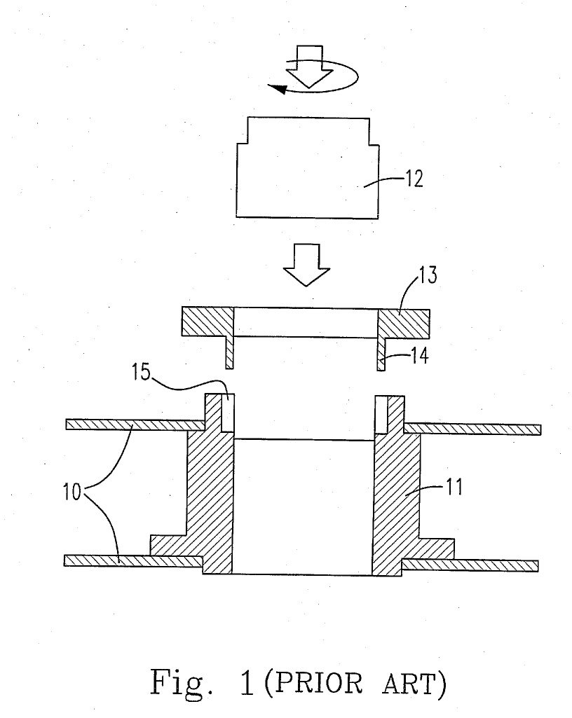

FIG. 2 is a schematic diagram showing the side section diagram of the circumgyration stopping instrument and lens holder in combination process;

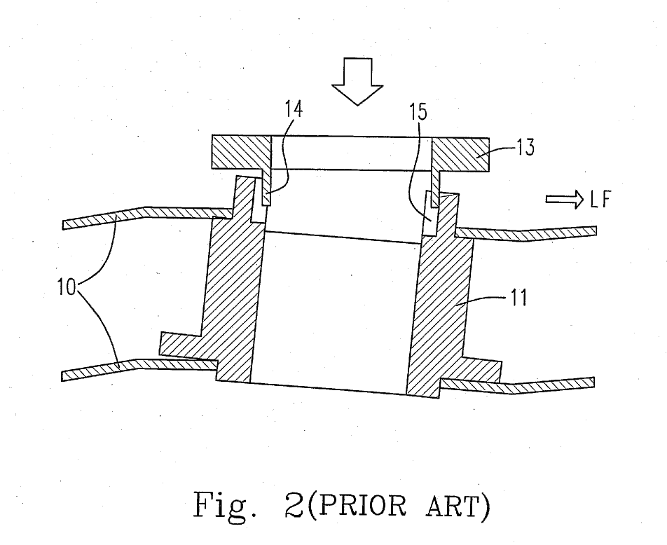

FIG. 3 is a schematic diagram showing the top view of the device for locking lens of the present invention;

FIG. 4 is a schematic diagram showing the device for locking lens combined with the circumgyration stopping instrument, rotatable positioning board and the base of the present invention;

FIG. 5 is a schematic diagram showing the A-A section of the device for locking lens shown in FIG. 3;

FIG. 6 is a schematic diagram showing the top view of the combination of the circumgyration stopping instrument, rotatable positioning board and the base of the present invention;

FIG. 7 is a schematic diagram showing the A-A section of the device for locking lens shown in FIG. 6;

FIG. 8 is the schematic three-dimensional diagram showing the combination of the circumgyration stopping instrument, rotatable positioning board and the base shown in FIG. 4 of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

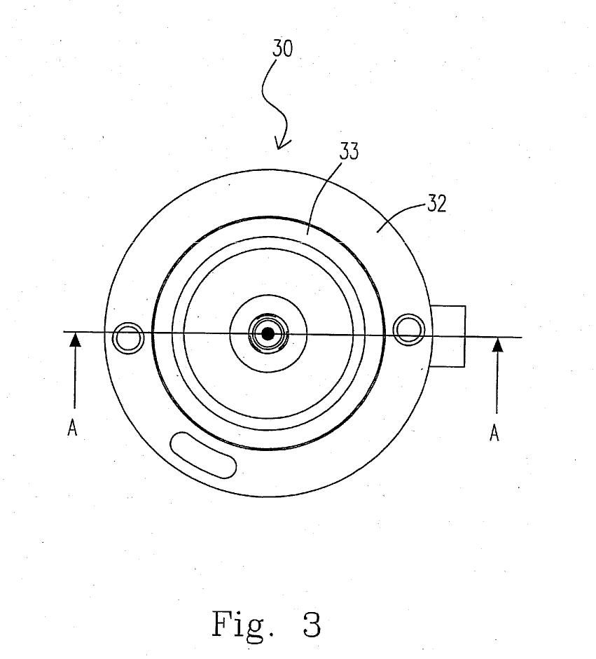

Please refer to FIG. 3, which is a schematic diagram showing the top view of the device for locking lens of the present invention. As shown in FIG. 3, the locking lens device 30 comprises a circumgyration stopping instrument 32 and a focusing ring 33, wherein the focusing ring 33 covers on a lens (not shown) needed to be adjusted for focusing.

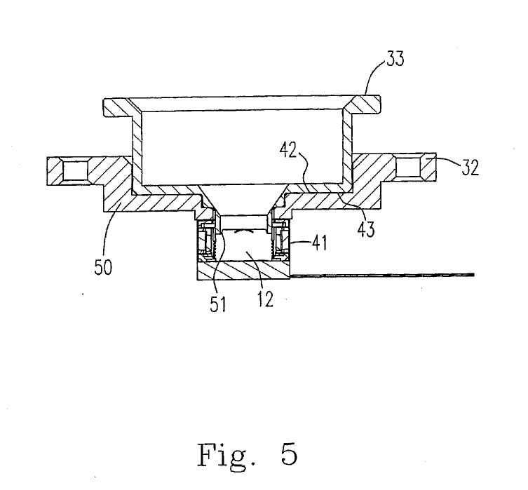

Please refer to FIG. 5, which is a schematic diagram showing the A-A section of the device for locking lens shown in FIG. 3. As shown in FIG. 5, the circumgyration stopping instrument 32 includes a normal stress enhancing part 50 formed as a funnel, whereby the pressure is concentrated to the bottom of the funnel and the normal stress the lens holder 41 receives is enhanced. The friction between the bottom surface 42 of the circumgyration stopping instrument 32 and the top surface 43 of the lens holder 41 is increased to prevent the lens holder 41 rotating while locking the lens 12 therein.

Furthermore, the dead weight of the circumgyration stopping instrument 32 and the normal stress enhancing part 50 further produce a pressure downward to the lens holder 41. The lens 12 has an indentation 51 configured to be inset by the focusing ring 33, and thereby the focusing ring 33 rotates to lock the lens 12 in the lens holder 41.

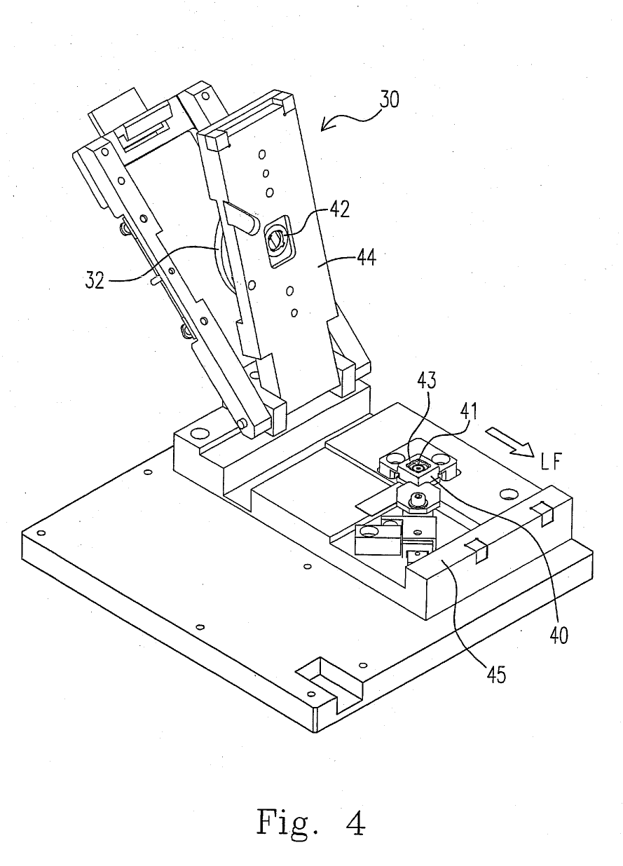

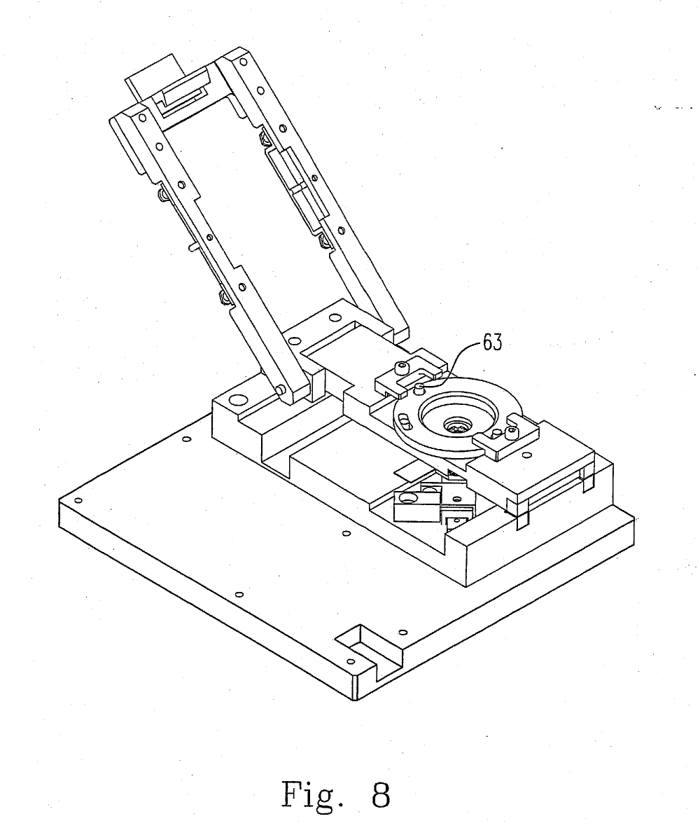

Please refer to FIG. 4, which is a schematic diagram showing the device for locking lens combined with the circumgyration stopping instrument, rotatable positioning board and the base of the present invention. As shown in FIG. 4, a locking device 30 is used for configuring the VCM 40 of the camera module of a cell phone. A lens holder 41 is configured in a VCM 40 and provided for a lens 12 locked therein. The locking device 30 is configured upward the lens holder 41 to lock the lens 12 therein. The bottom surface 42 of the circumgyration stopping instrument 32 is configured to urge against the top surface 43 of the lens holder 41 while locking and focusing a lens 12, wherein the bottom surface 42 and the top surface 43 is shaped flat to prevent a lateral force LF from being generated while the circumgyration stopping instrument 32 is coupled with the lens holder 41, as well as to prevent the lens holder 41 from being inclined and the leaf springs 10 from being deformed. The locking device 30 further includes a rotation position board 44, which is rotatably connected with a base 45. Please refer to FIG. 8, which is the schematic three-dimensional diagram showing the combination of the circumgyration stopping instrument, rotatable positioning board and the base shown in FIG. 4 of the present invention.

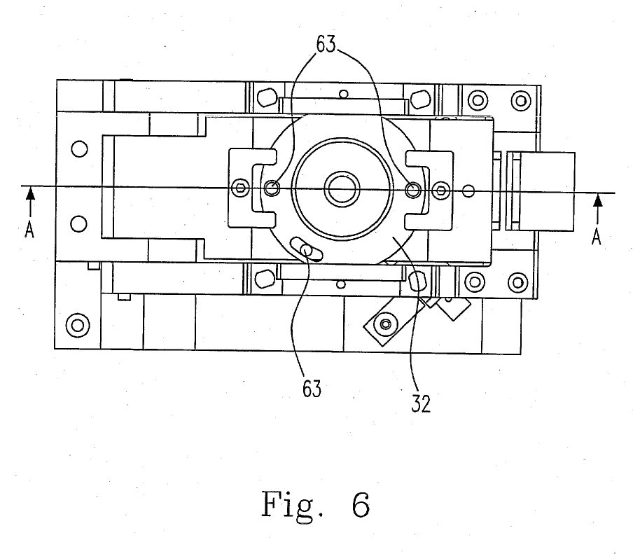

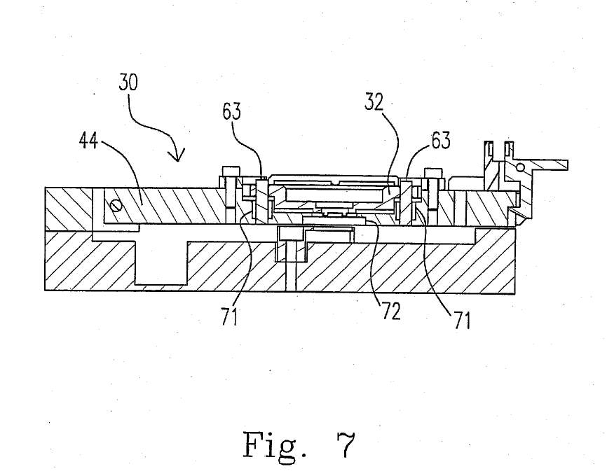

Please refer to FIG. 6, which is a schematic diagram of the top view showing the combination of the circumgyration stopping instrument, rotatable positioning board and the base of the present invention. As shown in FIG. 6, there are three position rods 63 in the sides of the circumgyration diagram showing the A-A section of the device for locking lens shown in FIG. 6. As shown in FIG. 7, the rotation position board 44 of the locking device 30 has the first fillisters 71 used for holding the position rods 63 so as to position the circumgyration stopping instrument 32 in the rotation position board 44. The rotation position board 44 further includes a second fillisters 71 used for containing the lens holder 41.

One of the main characteristics of the present invention is a locking device 30 locking lens 12 in a lens holder 41 configured in a voice-coil motor 40 of a camera module of a cell phone. The locking device 30 contains a circumgyration stopping instrument 32, which has a bottom surface 42 used for urging against the top surface 43 of the lens holder 41 for preventing a lateral stress from occurring on the lens holder 41 while the circumgyration stopping instrument 32 is coupled with the lens holder 41. The locking device 30 farther contains a focusing ring 33 fixing the lens to the lens holder 41.

Another one of the main characteristics of the invention is a locking method for fixing a lens 12 to a lens holder 41 and preventing the leaf springs 10 from being deformed. The method comprises steps of providing a circumgyration stopping device 32 having a bottom surface 42 and a focusing ring 33; urging the bottom surface 42 against the top surface 43 of a lens holder 41; putting the focusing ring 33 onto the lens 12 and fixing the lens 12 to the lens holder 41 by the focusing ring 33, wherein the top surface 43 of the lens holder 41 and the bottom surface 42 of the circumgyration stopping unit 32 have no bulges generating the lateral stress therebetween, so that the lens holder 41 is prevented from a lateral movement while the circumgyration stopping device 32 is coupled with the lens holder 41.

Consequently, a creative structure and process are provided to prevent a lateral stress and a lateral movement generated while the circumgyration stopping instrument coupled with the lens holder, wherein the circumgyration stopping instrument is configured with a bottom surface without bulges thereon and a normal stress enhancing part to enhance the normal stress and friction force the circumgyration stopping instrument applies on the lens holder.

Therefore, according to the device and method of the present invention, it becomes more convenient and accurate to position the circumgyration stopping instrument on the lens holder without generating a lateral stress and movement. Furthermore, the problems of how to stop the lens rotating without a position bulges bolts in the circumgyration stopping instrument, and how to rapidly position a weighted circumgyration stopping instrument on a rotation positioning board, are well solved by the devices and methods of the present invention.

In sum, the efficacy and the progression of the locking device and method of the present invention are surely obtained, while the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A lens locking device locking a lens into a lens holder, the device comprises:
a focusing ring fixing the lens to the lens holder; and
a circumgyration stopping unit having a bottom surface urging against a top surface of the lens holder for preventing a lateral stress from occurring on the lens holder while the circumgyration stopping unit is coupled with the lens holder.

2. The device according to claim 1, wherein the bottom surface urges the top surface with a normal stress so that a frictional force is generated between the bottom surface and the top surface to fix the lens holder to the circumgyration stopping unit, and the top surface and the bottom surface are both smooth.

3. The device according to claim 2, wherein the circumgyration stopping unit further comprises a funnel part enhancing the normal stress.

4. The device according to claim 1, wherein the lens has an indentation and the focusing ring is configured in the indentation and rotated to fix the lens to the lens holder.

5. The device according to claim 1, wherein the lens and the lens holder are configured in a voice-coil motor of a photographing module of a cell phone.

6. The device according to claim 1 further comprising a base supporting the lens holder and a rotation positioning board rotatably connected with the base.

7. The device according to claim 6, wherein the rotation positioning board comprises a first fillister holding a positioning rod for positioning the circumgyration stopping unit.

8. The device according to claim 7, wherein the rotation positioning board further comprises a second fillister containing the lens holder.

9. A lens locking apparatus, comprising:
a lens;
a lens holder having a top surface;
a circumgyration stopping instrument having a bottom surface urging against the top surface for preventing a lateral stress from occurring on the lens holder while the circumgyration stopping unit contacts with the lens holder.

10. The apparatus according to claim 9 wherein the lens has an indentation and a focusing ring is configured in the indentation to fix the lens to the lens holder.

11. The apparatus according to claim 9, wherein the bottom surface urges the top surface with a downward stress, and the bottom surface and the top surface have a frictional force therebetween to fix the lens holder to the circumgyration stopping instrument, and both of the top surface and the bottom surface are smooth.

12. The apparatus according to claim 11, wherein the circumgyration stopping instrument further comprises a first part enhancing the downward stress.

13. The apparatus according to claim 9, wherein the lens and the lens holder are configured in a voice-coil motor of a camera module of a cell phone.

14. The apparatus according to claim 9 further comprising a base supporting the lens holder and a rotatably positioning board connected to the base.

15. A method for locking a lens to a lens holder having a top surface, comprising steps of:
providing a stopping device having a bottom surface and a focusing ring;
urging the bottom surface against the top surface;
putting the focusing ring onto the lens; and
fixing the lens to the lens holder by the focusing ring,
wherein the lens holder is prevent from a lateral movement while the stopping device is coupled with the lens holder.

16. A method according to claim 15, wherein the step of fixing the lens to the lens holder is performed by rotating the lens by the focusing ring until the lens is fixed to the lens holder.

17. A method according to claim 15, wherein the urging step further comprises a step of enhancing a downward stress applied onto the top surface by an enhancing part of the stopping device.

18. A method according to claim 15, wherein the urging step further comprises a step of enhancing a frictional force between the top surface and the bottom surface to prevent the lens holder from rotating.

19. A method according to claim 15 further comprising steps of:
providing a positioning board; and
positioning the stopping device onto the positioning board.

20. A method according to claim 19 further comprising a step of:
providing a base having a rod rotatably connected with the positioning board and supporting the positioning board.
